(19) United States
(12) Patent Application Publication
(10) Pub. No.: US 2007/0130533 A1
(43) Pub. Date: Jun. 7, 2007

(54) Method for positioning display of icon or text on fan

(75) Inventor: Chen Hui Lai, Taipei Hsien (TW)

Correspondence Address: BACON & THOMAS, PLLC, 625 SLATERS LANE, FOURTH FLOOR, ALEXANDRIA, VA, 22314, US

(73) Assignee: POWER COOLER ENTERPRISE CO., LTD., Taipei Hsien (TW)

(21) Appl. No.: 11/291,877

(22) Filed: Dec. 2, 2005

(51) Int. Cl. A47F 11/06; G06F 3/00

(52) U.S. Cl. 715/769; 40/427

(57) ABSTRACT

A method for positioning a display of an icon or text on a fan comprises the following steps: setting any magnetic pole in a stator to be a first magnetic pole and generating a section of a first alternation with a length longer than other alternations when a rotor is magnetized inside of the stator; setting the first alternation to be a starting position and starting displaying procedures of the icon or the text; taking the starting position as 0° and setting a delay time according to an angle of a fan leave at which the icon or the text is displayed; displaying the preset icon or text through luminous bodies. Whereby, the starting position is set depending on the generation of the first alternation, and the displaying procedure of the icon or the text is triggered to allow the fan leaves body to be rotated to a specific angle to display the preset icon or text. Step 1: setting one magnetic pole in stator of luminous bodies for driving display of icon or text to be first magnetic pole and generating a section of first alternation different from other alternations in length when rotor is magnetized in stator. Step 2: setting first alternation in Step 1 to be starting position and starting procedure for displaying icon or text. Step 3: taking starting position in Step 2 as 0° and setting time between starting position to angle of fan leaves body at which icon or text is going to be displayed to be delay time Step 4: luminous bodies display preset icon or text after delay time.

### BACKGROUND OF THE INVENTION

1. Field of the Invention

The present invention relates to a method for positioning a display of an icon or a text on a fan, and more particularly to a method for controlling a fan to display an icon or a text at a specific angle.

2. Description of Related Art

One of current typical structures of active illumination fans is disclosed in Taiwan Patent N0. 590,166 titled as “Self-excited illumination-typed fan”. A fan disclosed in the patent comprises a housing, first coil set, fan leaves body and first magnetic element, it is characterized in that a self-excited illumination unit is disposed on the inner circumference of a cover of fan leaves body and the unit comprises a circuit board secured in the cover, an illumination element secured on the circuit board from with light is emitted to project on the cover, second coil set secured on the bottom face of the circuit board and a second magnetic element secured on the housing, and covers around the second coil set with a little interval between them, in which the second coil set is moved together with the fan leaves body to rotate relatively to the inner part of the second magnetic element to enable the second coil set to generate a conductive voltage to provide for the circuit board to cause the illumination element disposed on the surface thereof to be lighted on. A preset icon or text is allowed to be displayed by lighting on or off the illumination elements timely to cause them to be arranged in a line with a shape of an icon or a text when the fan is rotated. A person can see the icon or the text with a human's persistence of vision.

However, every time an angle at which an illumination elements display an icon or text cannot be matched with the rotating angle of a fan leaves body of a general fan because a stopping and rotation driving angle of the fan leaves body is fixed. It is more serious that the displayed icon or text may even be caused to be upside down.

### SUMMARY OF THE INVENTION

For solving the problems mentioned above, the present invention provides a method for positioning a display of an icon or a text on fan. The method is to set a starting position on a rotating angle and process a display procedure of the icon or the text according to the display of the starting position so as to attain to an object displaying the icon or the text at a specific position.

For attaining to the object mentioned above, a method for controlling a display of an icon or a text of a fan according to the present invention comprises the following steps:

Step 1: setting one magnetic pole in a stator of a illumination bodies serving for driving a display of an icon or a text to be a first magnetic pole and generating a section of a first alteration with a length different from the length of other alterations when the stator is magnetized in a rotor;

Step 2: setting the first alteration in step 1 to be a starting position and starting a procedure for displaying an icon or a text;

Whereby, the procedure for displaying an icon or a text is to generate a first alternation and take it as a starting position, start the procedures of an icon or a text and cause a preset icon or text to be displayed when the fan is rotated to a specific angle.

According to a preferred embodiment of the present invention, the started procedure for displaying an icon or text comprises the following steps:

Step 3: taking the starting position in step 2 as 0° and setting a time period between the starting position and an angle of a fan leaves body at which the icon or the text wants to be displayed to be a delay time;

Step 4 displaying the preset icon or text through luminous bodies after the delay time.

According to a preferred embodiment of the present invention, the icon or the text is displayed when the angle of the fan leaves is 0°, i.e. the delay time is 0 sec.

According to the embodiment of the present invention, the delay time mentioned above must not be larger than a time for a fan leaves body to rotate one cycle. For example, the time for the fan leaves body to rotate one cycle is 0.1 sec when the rotating speed of the fan is 600 rpm so that the delay time must be not shorter than 0.1 sec.

### BRIEF DESCRIPTION OF THE DRAWINGS

The present invention can be more fully understood by reference to the following description and accompanying drawings, in which:

FIG. 1 is a flow chart, showing steps for positioning a display of an icon or text on a fan of a preferred embodiment according to the present invention;

FIG. 2 is a graph of a waveform of induced voltages generated from a stator and rotor when a method for positioning a display of an icon or text on a fan of a preferred embodiment according to the present invention is adopted; and

FIG. 3 is a schematic view, showing that a fan leaves body is rotated to a specific angle and an icon or text is displayed when a method for positioning a display of an icon or text on a fan of a preferred embodiment according to the present invention is adopted.

### DETAILED DESCRIPTION OF THE PREFERRED EMBODIMENTS

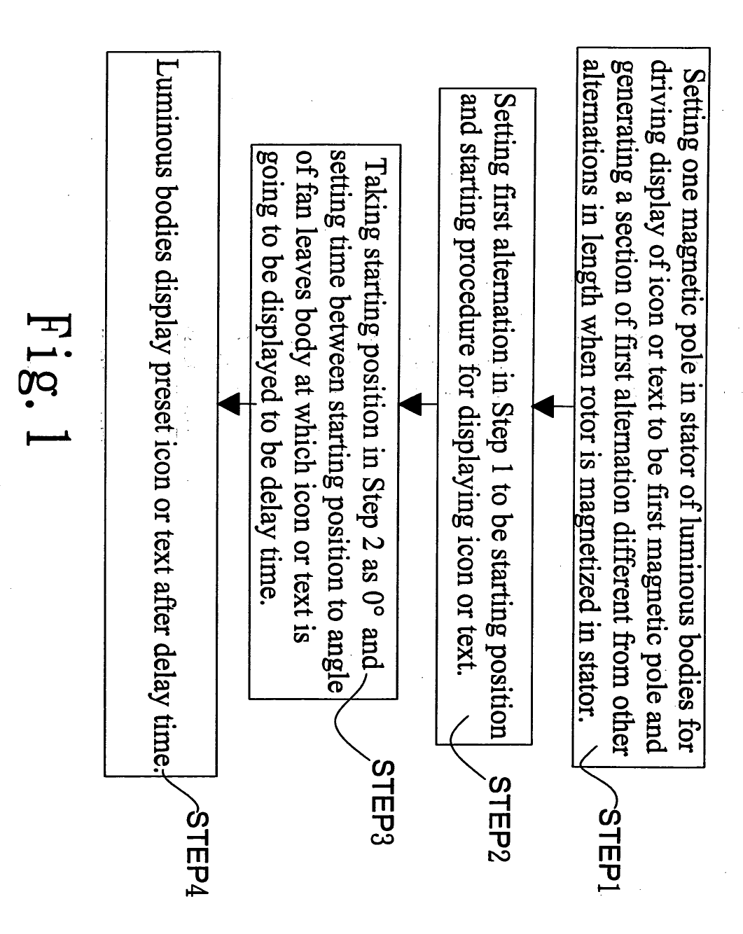

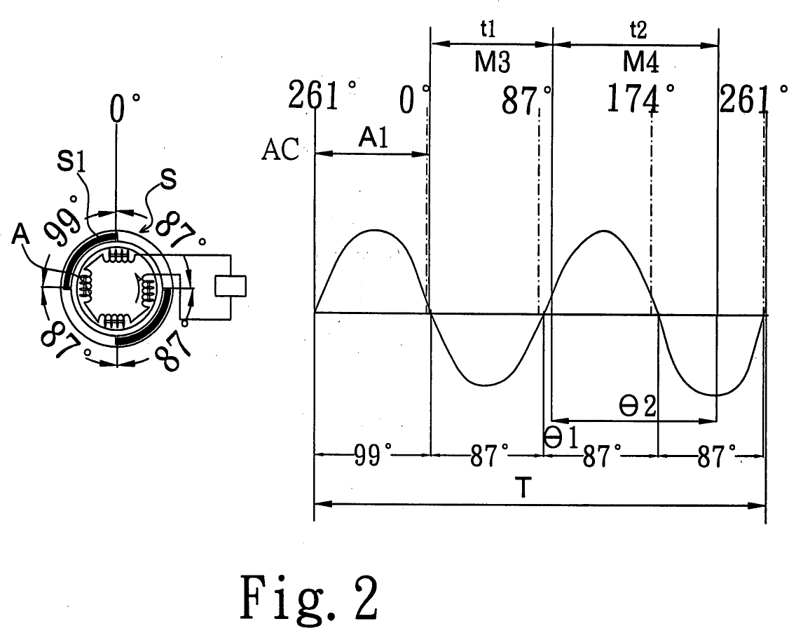

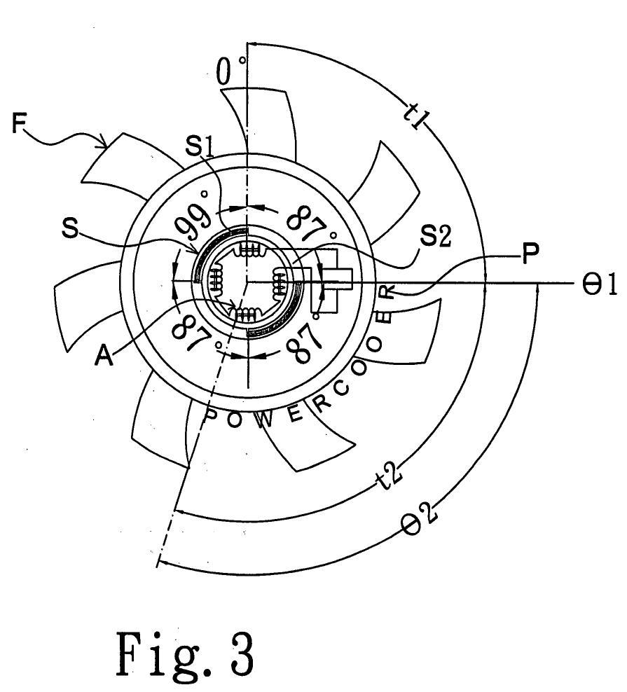

Please refer to FIGS. 1, 2 and 3. FIG. 1 is a flow chart showing steps of a method for positioning a display of an icon or text of a fan of a preferred embodiment of the present invention, FIG. 2 is a graph of a waveform of induced voltages generated from a stator and rotor when a method for positioning a display of an icon or text on a fan of a preferred embodiment according to the present invention is adopted; and FIG. 3 is a schematic view showing that a fan leaves body is rotated to a specific angle and an icon or text is displayed when a method for positioning a display of an icon of text on a fan of a preferred embodiment according to the present invention is adopted.

As the figures show, a method for positioning a display of an icon or text on a fan of the present invention is used to control a display of an icon or a text P when a fan F is rotated to a specific angle to avoid the problem in a conventional illumination structure causing a display position of the icon or the text P to be different every time, the method comprises the following steps:

Step 1: setting any one of magnetic poles in a stator S of luminous bodies served for driving the display of the icon or the text to be a first magnetic pole S1 and the length thereof to be longer or shorter than other magnetic poles S2 to allow the time for magnetizing a rotor in the magnetic pole S1 to be longer or shorter than in the other magnetic poles S2 when the rotor A is rotated in the stator S so as to generate a section of longer or shorter alternation. Here, refer such kind of alternation to a first alternation A1;

Step 2: detecting waveform changes generated from the relative rotation between the rotor Q and the stator S. When the first alternation A1 in step 1 is generated, because the time for generating the alternation A1 is definitely longer or shorter than the time for generating other alternations, at this time, when the alternation generated through a longer or shorter time is detected, it means that the rotor A have already been rotated one cycle and returned to 0°, and the display procedure of the icon or the text is started at the same time. The started display procedures of the icon or the text comprise:

Step 3: taking the starting position in step 2 as 0° and setting a time between the starting position and an angle of a fan leaves body at which the icon or the text is going to be displayed to be a delay time t1; the calculation for the delay time t1 is:

Delay time t1=starting angle for displaying a icon or text θ1×(time needed for a fan leaves body to rotate one cycle T/360).

If the starting position 0° for displaying the icon or the text P, the delay time is 0 sec; and, the delay time not only can control the display position of the icon or the text P, but also allow the text or the text P to be displayed at a preset accurate position so as to prevent the display position thereof to be improper such as upside down.

Step 4: according to the delay time t1 in Step 3, starting displaying the preset icon or text P when the a fan leaves body S1 arrives the starting angle θ1 for displaying the icon or the text P; whereby, Step 1 to Step 4 can effectively control the icon or text P to be displayed when the fan leaves body is rotated to a specific position. This can avoid causing the display position of the icon or text P to be different every time when the fan leaves body stops every time or the driving angle thereof is different.

According to the method for positioning a display of an icon or text on a fan of the present invention, the delay time t1 in Step 3 is not larger than the time T to rotate the fan leaves body one cycle; if the delay time t1 is equal to or larger than T, the icon or text P displayed in Step 4 cannot be displayed effectively.

Please refer to FIG. 3 again. When the position that luminous bodies installed on the fan leaves F display the icon or text wants to be controlled, first of all, a starting position of the fan must be set and referred to 0°. A method for setting a starting position in the present invention comprises the following steps: controlling an alternation generated at the time when the rotor A cuts magnetic fields in the stator S; referring one of alternations to a first alternation A1, in which the length thereof must be longer or shorter than other alternations; starting the procedure for displaying the icon or the text (Step 2) when the longer or the shorter alternation generated from the rotation of the rotor A in the stator S is detected, i.e. the rotor A has been rotated one cycle and returned to zero; and starting the procedures for displaying the icon or text (Step 2); and setting a delay time t1 to cause the fan leaves body to be corresponded to the angle of the starting position when the icon or text P is displayed (Step 3). For example, if the rotating speed of the fan leaves body is 1200 rpm, the time needed for one cycle is 1/20 sec (i.e. 20 cycles per one second), and if the icon or the text wants to be controlled to display when the fan leaves are turned to an angle of 90°, because the angle for the fan leaves to be rotated one cycle is 360°, the time needed for the fan leaves body to be turned to 90° is 1/20 sec times (90°/360°), i.e. 0.0125 sec, this is the so-called delay time t1 in the present invention. This allows the icon or the text P to be displayed when the fan leaves body is rotated to 90° (Step 4) so as to attain to the object displaying the icon or text at a specific position.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for positioning a display of an icon or text on a fan, comprising the following steps:
Step 1: setting one magnetic pole in a stator driving luminous bodies serving for displaying an icon or text to be a first magnetic pole, generating a section of a first alternation longer or shorter than other alternations when a rotor is magnetized in said stator;
Step 2: setting said first alternation in Step 1 to be a starting position, starting displaying procedures of said icon or said text;
Step 3: taking said starting position in Step 2 as 0°, and setting time between said starting position to an angle of a fan leaves body at which said icon or said text is going to be displayed to be a delay time; and
Step 4: displaying said preset icon or text through said luminous bodies at said delay time;
Whereby, said first alternation is taken as said starting position to starting said displaying procedures of said icon or said text so as to allow said preset icon or text to be displayed when said fan leaves body is rotated to a specific angle.

2. The method according to claim 1, wherein said delay time is not longer than the time for said fan leaves body to rotate in one cycle.

3. The method according to claim 1, wherein a length of said first magnetic pole serving for generating said first alternation is different from other magnetic poles; whereby, an alternation with a longer or shorter length is generated.
